(19) United States
(12) Patent Application Publication
(10) Pub. No.: US 2018/0220369 A1
(43) Pub. Date: Aug. 2, 2018

(54) Device and Method of Handling an Inactive State in a Wireless Communication System

(71) Applicant: HTC Corporation, Taoyuan City (TW)

(72) Inventor: Chih-Hsiang Wu, Taoyuan City (TW)

(21) Appl. No.: 15/885,848

(22) Filed: Feb. 1, 2018

Related U.S. Application Data
(60) Provisional application No. 62/453,515, filed on Feb. 2, 2017.
(60) Provisional application No. 62/523,244, filed on Jun. 21, 2017.

(51) Int. Cl. H04W 52/02; H04W 74/08; H04W 76/19

(52) U.S. Cl. CPC H04W 52/0225; H04W 76/19; H04W 74/0833

(57) ABSTRACT

A communication device of handling an inactivate state comprises a storage device and a processing circuit coupled to the storage device. The storage device stores, and the processing circuit is configured to execute instructions of entering a RRC_INACTIVE state; initiating a random access (RA) procedure for transmitting data, when the communication device is in the RRC_INACTIVE state; detecting that a RA problem occurs in the RA procedure; and transferring to a RRC_IDLE state in response to the RA problem, or initiating a radio resource control (RRC) connection resume procedure or a RRC connection reestablishment procedure in response to the RA problem.

### CROSS REFERENCE TO RELATED APPLICATIONS

This application claims the benefits of U.S. Provisional Application No. 62/453,515 filed on Feb. 2, 2017 and U.S. Provisional Application No. 62/523,244 filed on Jun. 21, 2017, which are incorporated herein by reference.

### BACKGROUND OF THE INVENTION

### 1. Field of the Invention

The present invention relates to a device and a method used in a wireless communication system, and more particularly, to a device and a method of handling an inactivate state in a wireless communication System.

### 2. Description of the Prior Art

When a UE communicates with a base station (BS), the UE may operate in one of multiple states. In one example, the UE may perform a data transmission unsuccessfully, when the UE is in an inactive state. It is unknown how the UE in the inactive state handles the unsuccessful (i.e., failed) data transmission.

### SUMMARY OF THE INVENTION

The present invention therefore provides a communication device and method for handling an inactivate state to solve the abovementioned problem.

A communication device of handling an inactivate state comprises a storage device and a processing circuit coupled to the storage device. The storage device stores, and the processing circuit is configured to execute instructions of entering a RRC_INACTIVE state; initiating a random access (RA) procedure for transmitting data, when the communication device is in the RRC_INACTIVE state; detecting that a RA problem occurs in the RA procedure; and transferring to a RRC_IDLE state in response to the RA problem, or initiating a radio resource control (RRC) connection resume procedure or a RRC connection reestablishment procedure in response to the RA problem.

A communication device of handling an inactivate state comprises a storage device and a processing circuit coupled to the storage device. The storage device stores, and the processing circuit is configured to execute instructions of entering a RRC_INACTIVE state; initiating a transmission of a Protocol Data Unit (PDU), when the communication device is in the RRC_INACTIVE state; and transferring to a RRC_IDLE state when the communication device fails to complete the transmission within the maximum number of retransmissions of the PDU, or initiating a radio resource control (RRC) connection resume procedure or a RRC connection reestablishment procedure when the communication device fails to complete the transmission within the maximum number of retransmissions of the PDU.

A communication device of handling an inactivate state comprises a storage device and a processing circuit coupled to the storage device. The storage device stores, and the processing circuit is configured to execute instructions of initiating a first random access (RA) procedure for a data transmission, when the communication device is in a RRC_INACTIVE state; detecting that a RA problem occurs in the RA procedure; and not initiating a radio resource control (RRC) connection reestablishment procedure in response to the RA problem.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

FIG. 4 is a flowchart of a process according to an example of the present invention.

FIG. 5 is a flowchart of a process according to an example of the present invention.

FIG. 6 is a flowchart of a process according to an example of the present invention.

FIG. 7 is a flowchart of a process according to an example of the present invention.

FIG. 8 is a flowchart of a process according to an example of the present invention.

FIG. 9 is a flowchart of a process according to an example of the present invention.

FIG. 10 is a flowchart of a process according to an example of the present invention.

### DETAILED DESCRIPTION

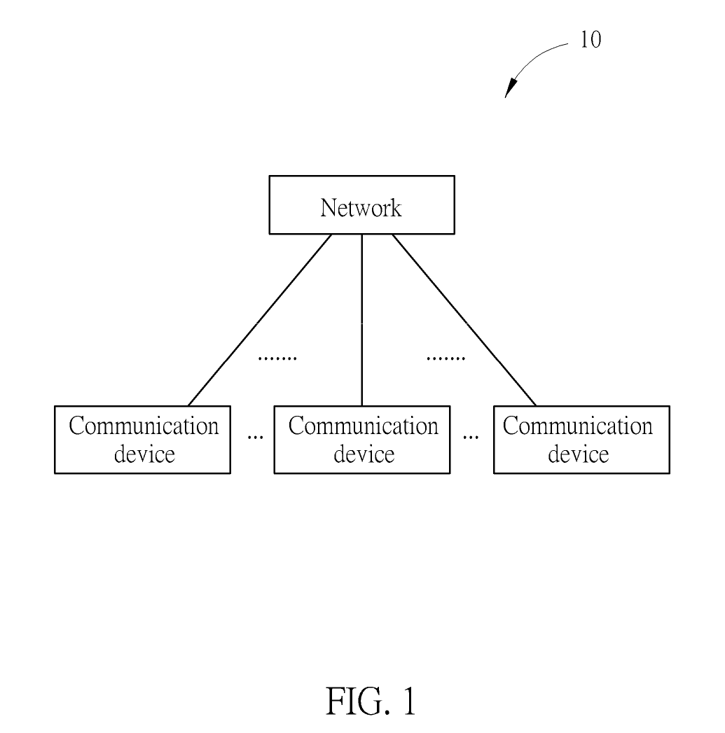

FIG. 1 is a schematic diagram of a wireless communication system 10 according to an example of the present invention. The wireless communication system 10 is briefly composed of a network and a plurality of communication devices. The network and a communication device may communicate with each other via one or more carriers of licensed band(s) and/or unlicensed band(s). The network and the communication device may communicate with each other via one or multiple cells (e.g., multiple carriers) belonging to one or multiple base stations (BSs).

In FIG. 1, the network and the communication devices are simply utilized for illustrating the structure of the wireless communication system 10. Practically, the network includes an evolved universal terrestrial radio access network (E-UTRAN) and/or a 5G radio access network (RAN). The E-UTRAN includes at least one evolved Node-B (eNB), and the 5G RAN includes at least one 5G base station (BS) (or called gNB or evolved LTE eNB). The network may include an evolved packet core (EPC) network and/or a 5G core network (5GC). The EPC network may include a mobility management entity (MME) and a serving gateway. The 5GC may include an Access and Mobility Management Function, a Session Management Function, a User Plane Function and an Authentication Server Function.

A communication device may be a user equipment (UE), a mobile phone, a laptop, a tablet computer, an electronic book, a portable computer system, a vehicle, a ship or an aircraft. In addition, the network and the communication device can be seen as a transmitter or a receiver according to a direction of a transmission (i.e., transmission direction), e.g., for an uplink (UL), the communication device is the transmitter and the network is the receiver, and for a downlink (DL), the network is the transmitter and the communication device is the receiver.

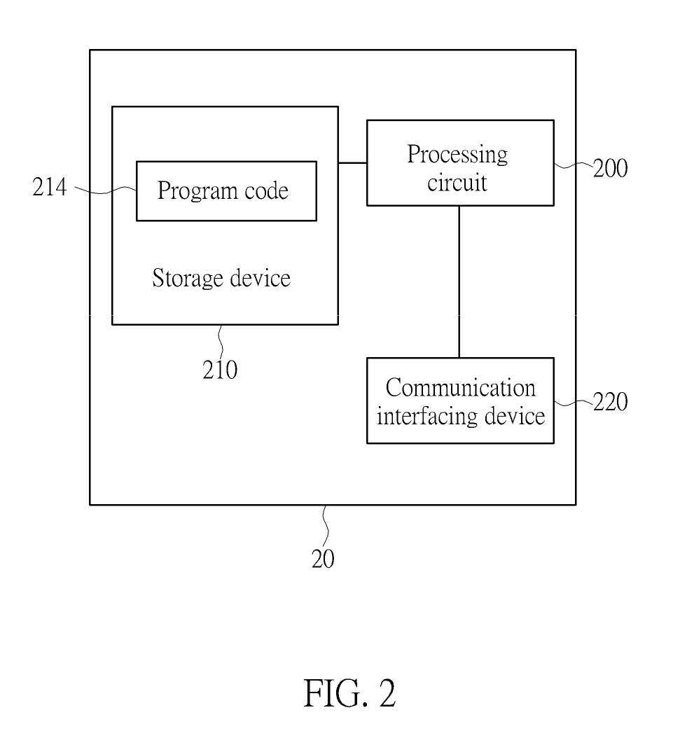

FIG. 2 is a schematic diagram of a communication device 20 according to an example of the present invention. The communication device 20 may be a communication device or the network shown in FIG. 1, but is not limited herein. The communication device 20 may include a processing circuit 200 such as a microprocessor or Application Specific Integrated Circuit (ASIC), a storage device 210, a communication interfacing device 220 and a communication interfacing device 240. The storage device 210 may be any data storage device that may store a program code 214, accessed and executed by the processing circuit 200. Examples of the storage device 210 include but are not limited to a subscriber identity module (SIM), read-only memory (ROM), flash memory, random-access memory (RAM), hard disk, optical data storage device, non-volatile storage unit, non-transitory computer-readable medium (e.g., tangible media), etc. The communication interfacing devices 220 and 240 are preferably are transceivers used to transmit and receive signals (e.g., data, messages and/or packets) according to processing results of the processing circuit 200.

In the following examples, a UE is used to represent a communication device in FIG. 1, to simplify the illustration of the embodiments.

A UE may enter a RRC_INACTIVE state from the RRC_CONNECTED state or the RRC_IDLE state. The UE may enter the RRC_CONNECTED state from the RRC_IDLE state or the RRC_INACTIVE state. To simplify the following description, the RRC_INACTIVE state represents either a RRC_CONNECTED state with a light connection in a long-term evolution (LTE) system (e.g., 4G system) or a RRC_INACTIVE state in a new radio (NR) system (e.g., 5G system).

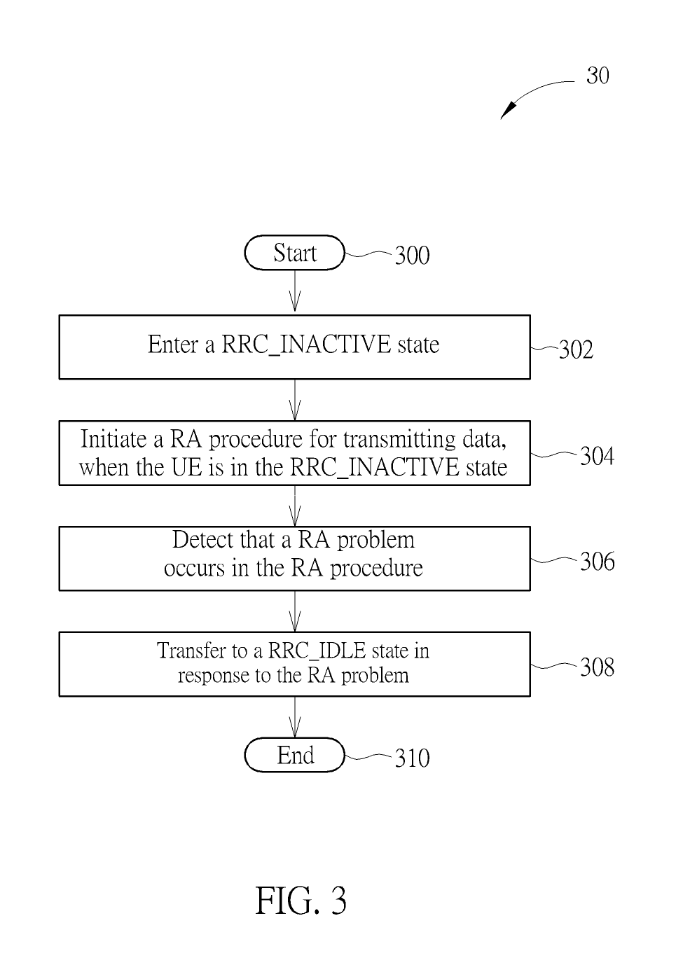

A process 30 shown in FIG. 3 may be utilized in a UE, and includes the following steps:

Step 300: Start.

Step 302: Enter a RRC_INACTIVE state.

Step 304: Initiate a random access (RA) procedure for transmitting data, when the UE is in the RRC_INACTIVE state.

Step 306: Detect that a RA problem occurs in the RA procedure.

Step 308: Transfer to a RRC_IDLE state in response to the RA problem.

Step 310: End.

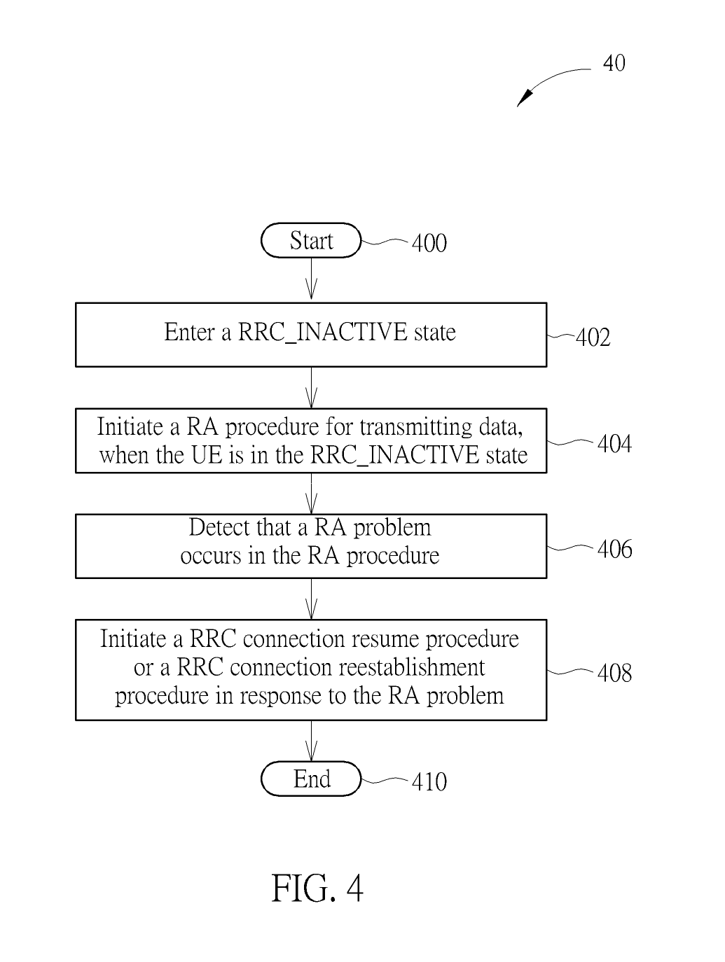

A process 40 shown in FIG. 4 may be utilized in a UE, and includes the following steps:

Step 400: Start.

Step 402: Enter a RRC_INACTIVE state.

Step 404: Initiate a RA procedure for transmitting data, when the UE is in the RRC_INACTIVE state.

Step 406: Detect that a RA problem occurs in the RA procedure.

Step 408: Initiate a radio resource control (RRC) connection resume procedure or a RRC connection reestablishment procedure in response to the RA problem.

Step 410: End.

The following examples may be applied to the processes 30-40.

In one example, the UE detects the RA problem, when the UE has transmitted the maximum number of transmissions of at least one preamble without receiving a RA response or a contention resolution message for the UE. For example, in each transmission of the maximum number of transmissions, the UE does not receive a RA response including an identifier corresponding to a transmitted preamble of the at least one preamble. For example, in each transmission of the maximum number of transmissions, the UE receives the RA response but does not receive a contention resolution message addressing the UE for a scheduled transmission. The scheduled transmission may include the data (e.g., an internet protocol (IP) packet or a RRC message). When the UE receives the contention resolution message, the UE successfully complete the RA procedure and keeps staying in the RRC_INACTIVE state.

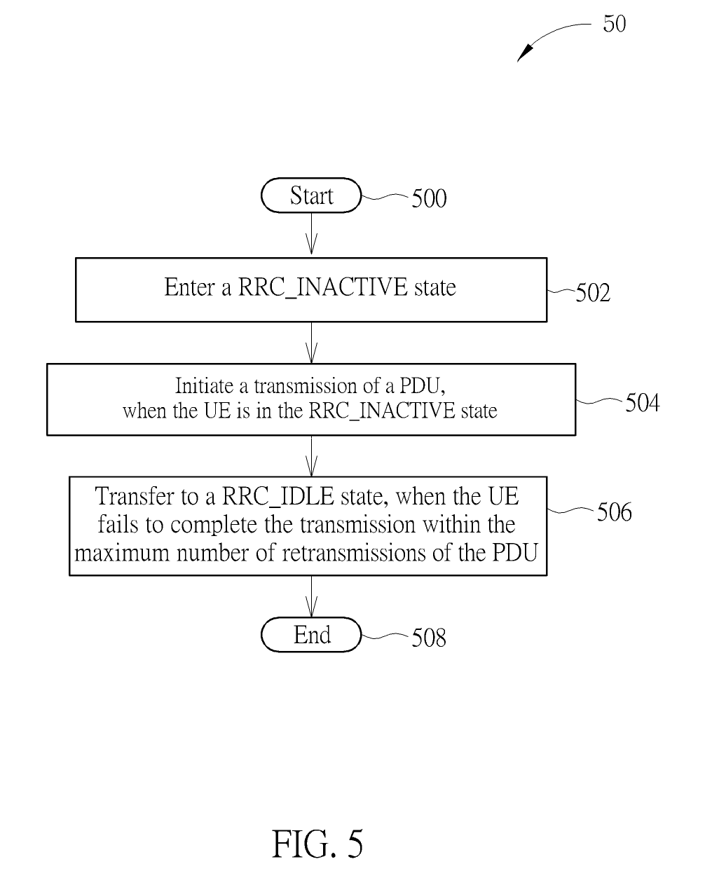

A process 50 shown in FIG. 5 may be utilized in a UE, and includes the following steps:

Step 500: Start.

Step 502: Enter a RRC_INACTIVE state.

Step 504: Initiate a transmission of a Protocol Data Unit (PDU), when the UE is in the RRC_INACTIVE state.

Step 506: Transfer to a RRC_IDLE state, when the UE fails to complete the transmission within the maximum number of retransmissions of the PDU.

Step 508: End.

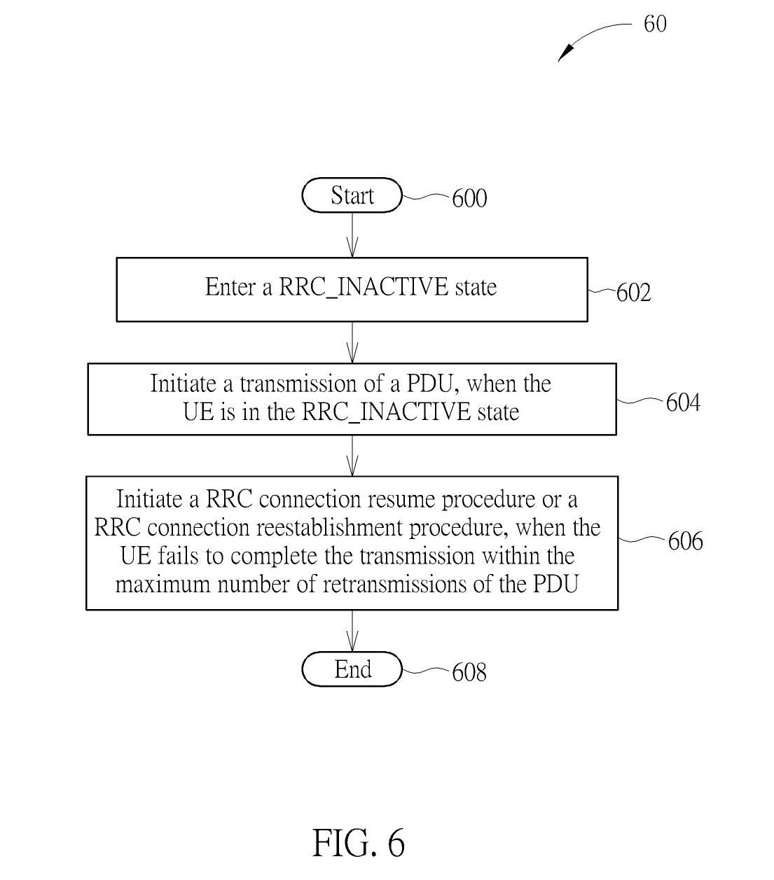

A process 60 shown in FIG. 6 may be utilized in a UE, and includes the following steps:

Step 600: Start.

Step 602: Enter a RRC_INACTIVE state.

Step 604: Initiate a transmission of a PDU, when the UE is in the RRC_INACTIVE state.

Step 606: Initiate a RRC connection resume procedure or a RRC connection reestablishment procedure, when the UE fails to complete the transmission within the maximum number of retransmissions of the PDU.

Step 608: End.

The following examples may be applied to the processes 50-60.

In one example, the PDU is a Packet Data Convergence Protocol (PDCP) PDU, a radio link control (RLC) PDU or a medium access control (MAC) PDU. In one example, the PDU includes an IP packet or a RRC message.

In one example, the UE fails to complete the transmission of the PDU to the network, since (e.g., if) the UE does not receive any acknowledgement for acknowledging a reception of the PDU from the network in each transmission of the PDU.

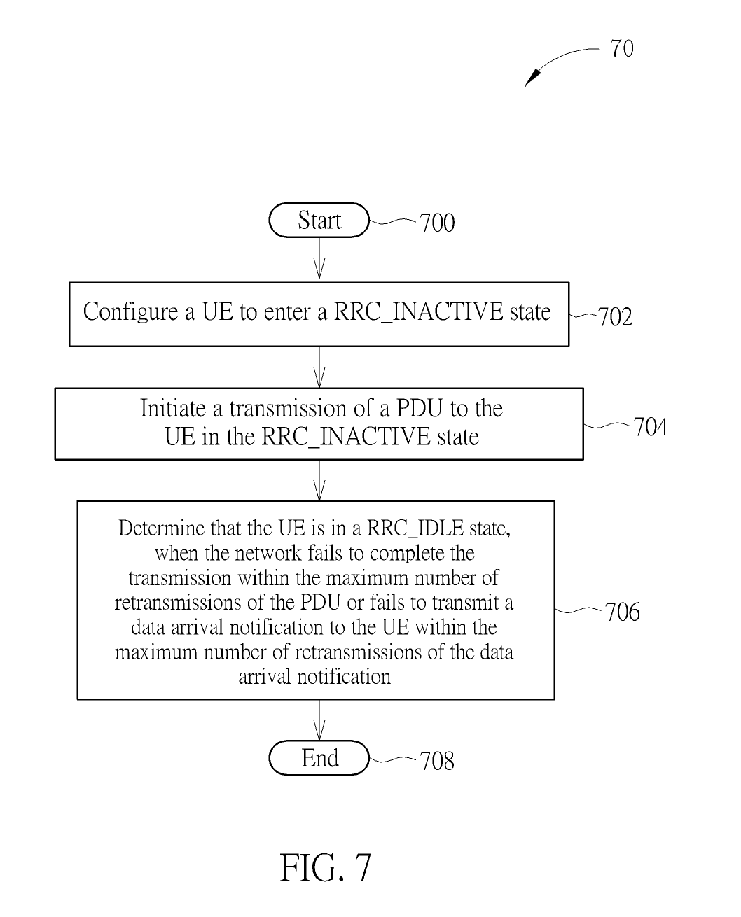

A process 70 shown in FIG. 7 may be utilized in a network, and includes the following steps:

Step 700: Start.

Step 702: Configure a UE to enter a RRC_INACTIVE state.

Step 704: Initiate a transmission of a PDU to the UE in the RRC_INACTIVE state.

Step 706: Determine that the UE is in a RRC_IDLE state, when the network fails to complete the transmission within the maximum number of retransmissions of the PDU or fails to transmit a data arrival notification to the UE within the maximum number of retransmissions of the data arrival notification.

Step 708: End.

In one example, the UE fails to complete the transmission of the PDU to the network, since the UE does not receive any acknowledgement acknowledging a reception of the PDU from the network in each transmission of the PDU.

In an example, the network may transmit a paging message to the UE for the transmission of the PDU or a new PDU to the UE, when determining that the UE is in the RRC_IDLE state. Thus, the UE in the RRC_IDLE state initiates a RRC connection establishment procedure to enter the RRC_CONNECTED state in response to the paging message. The network may configure a data radio bearer (DRB) to the UE in a RRCConnectionSetup message of the RRC connection establishment procedure, or may configure the DRB to the UE in a RRCConnectionReconfiguration message on a signaling radio bearer (SRB) established by the RRC connection establishment procedure. Then, the network performs the transmission of the PDU or the new PDU to the UE via the DRB.

In one example, the network fails to complete the transmission of the PDU to the UE, since the network does not receive any acknowledgement acknowledging a reception of the PDU from the UE in each transmission of the PDU. In one example, the network fails to transmit the data arrival notification to the UE in each transmission of the data arrival notification, since the network does not receive a RA preamble responding to the data arrival notification.

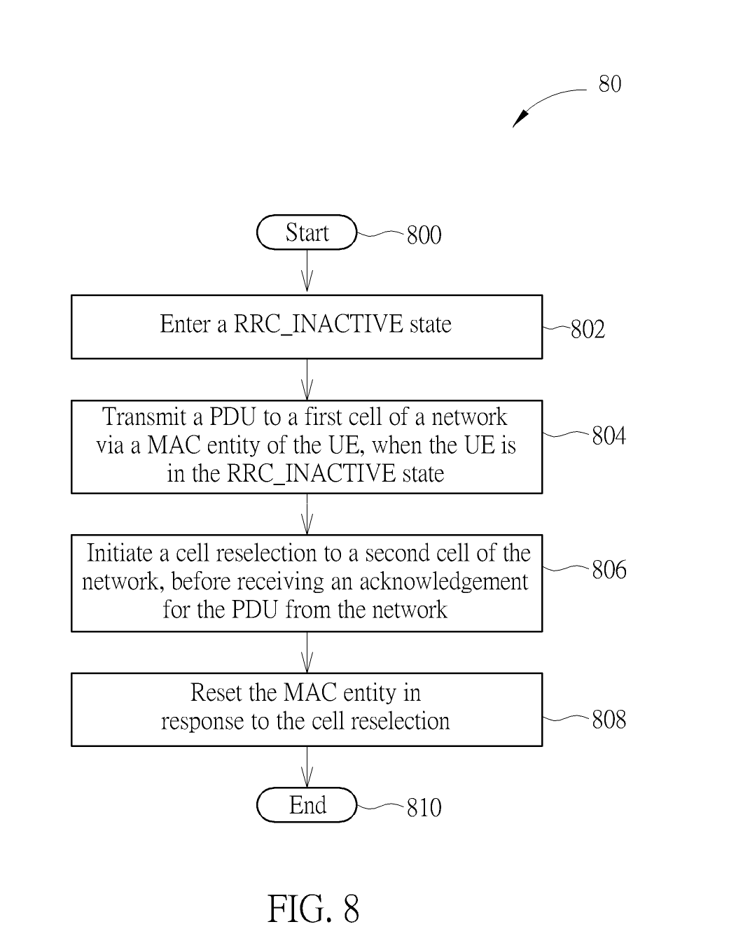

A process 80 shown in FIG. 8 may be utilized in a UE, and includes the following steps:

Step 800: Start.

Step 802: Enter a RRC_INACTIVE state.

Step 804: Transmit a PDU to a first cell of a network via a MAC entity of the UE, when the UE is in the RRC_INACTIVE state.

Step 806: Initiate a cell reselection to a second cell of the network, before receiving an acknowledgement for the PDU from the network.

Step 808: Reset the MAC entity in response to the cell reselection.

Step 810: End.

In one example, the PDU is a Packet Data Convergence Protocol (PDCP) PDU, a radio link control (RLC) PDU or a medium access control (MAC) PDU. In one example, the PDU includes an IP packet or a RRC message. In one example, the acknowledgement is a PDCP status report, a RLC acknowledgement or a hybrid automatic repeat request (HARQ) acknowledgement, which is transmitted by the network to acknowledge a reception of the PDU.

The UE may not receive the acknowledgment from the network, when the cell reselection occurs. After reselecting to the second cell, the UE may retransmit the PDU to the network via the second cell by the reset MAC entity.

In one example, the UE is configured a DRB by the network, and the PDU is associated to the DRB. The UE may receive a DRB configuration configuring the DRB and a MAC configuration configuring the MAC entity, from the network. The UE configures the MAC entity according to the MAC configuration. The UE may reestablish at least one of a RLC entity associated to the DRB and a PDCP entity associated to the DRB in response to the cell reselection. In one example of resetting/reestablishing the MAC/RLC/PDCP entity, the UE may reset state variable(s), stop timer(s) and/or stop counter(s) in the MAC/RLC/PDCP entity. In one example of resetting the MAC entity, the UE may set a NDI for an uplink HARQ process to a default value (e.g. 0), flush a soft buffer for a downlink HARQ process, and/or consider the next received transmission for a TB as the very first transmission.

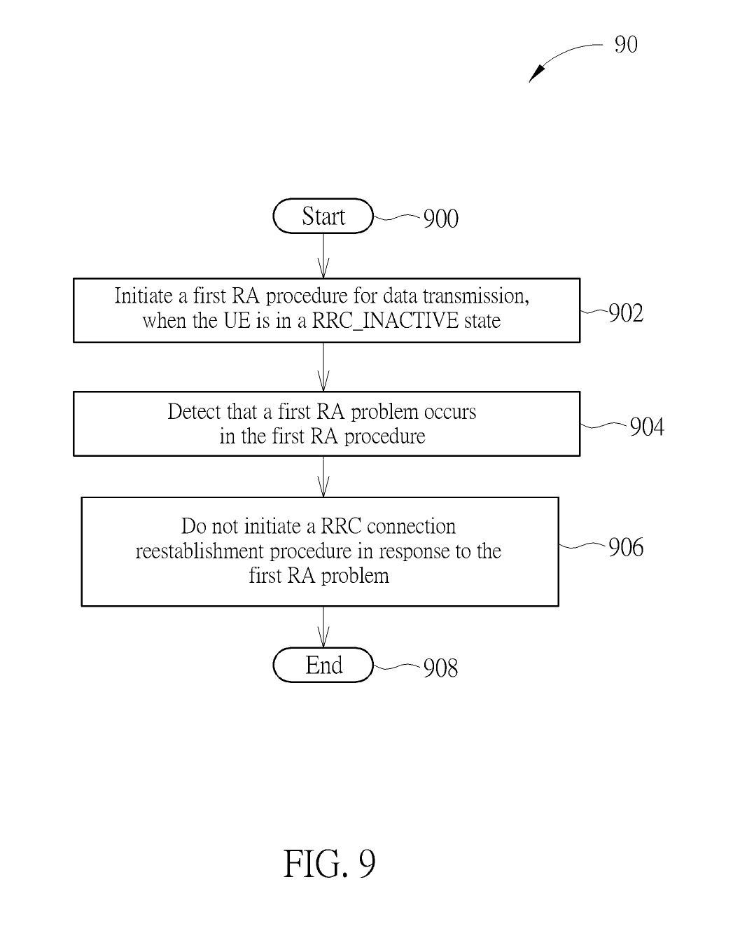

A process 90 shown in FIG. 9 may be utilized in a UE, and includes the following steps:

Step 900: Start.

Step 902: Initiate a first RA procedure for data transmission, when the UE is in a RRC_INACTIVE state.

Step 904: Detect that a first RA problem occurs in the first RA procedure.

Step 906: Do not initiate a RRC connection reestablishment procedure in response to the first RA problem.

Step 908: End.

In one example, the UE in a RRC_CONNECTED state initiates a second RA procedure for the data transmission (e.g., IP packet or RRC message). The UE detects that a second RA problem occurs in the second RA procedure. Then, the UE initiates the RRC connection reestablishment procedure in response to the second RA problem.

In one example, the UE initiates a RA procedure (e.g., the first RA procedure or the second RA procedure) for data transmission (e.g., IP packet or RRC message). The UE detects that a RA problem (e.g., the first RA problem or the second RA problem) occurs in the RA procedure. If the UE is in the RRC_INACTIVE state and detects the RA problem, the UE does not initiate a RRC connection reestablishment procedure in response to the RA problem. If the UE is in the RRC_CONNECTED state and detects the RA problem, the UE initiates the RRC connection reestablishment procedure.

In one example, the UE “disables initiating” (or “is not allowed to initiate”) the RRC connection reestablishment procedure, when entering the RRC_INACTIVE state. That is, when the UE in the RRC_INACTIVE state detects the RA problem, the UE does not initiate (or not perform) the RRC connection reestablishment procedure. The UE “enables initiating” (or “is allowed to initiate”) the RRC connection reestablishment procedure, when entering the RRC_CONNECTED state.

In one example, the UE “disables detecting” (or “is not allowed to detect”) the RA problem, when entering the RRC_INACTIVE state. That is, the UE in the RRC_INACTIVE state does not detect the RA problem. Thus, the UE does not initiate the RRC connection reestablishment procedure in the RRC_INACTIVE state. The UE may keep performing the RA procedure until a timer expires. When the timer expires, the UE stops the RA procedure. The UE may stop the timer, when the UE performs the RA procedure successfully or receives a response data (e.g., including an IP packet or a RRC response message) for responding to the data transmission. The UE may perform the data transmission, and receive the response data in the RA procedure. The UE may start the timer, when initiating the data transmission or when initiating the RA procedure. In one example, the UE enables detecting the RA problem, when entering the RRC_CONNECTED state.

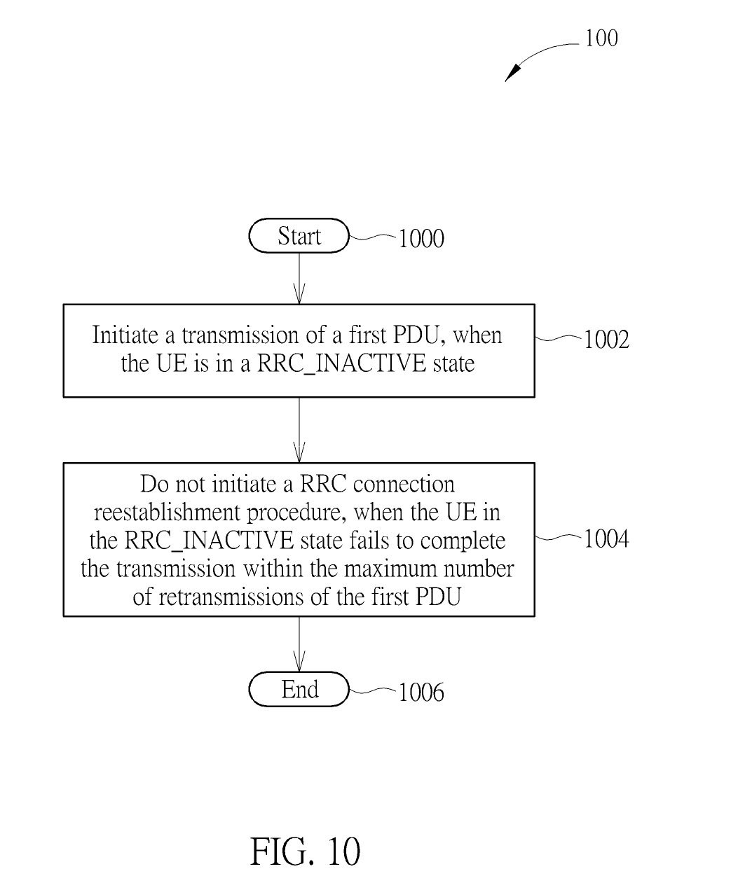

A process 100 shown in FIG. 10 may be utilized in a UE, and includes the following steps:

Step 1000: Start.

Step 1002: Initiate a transmission of a first PDU, when the UE is in a RRC_INACTIVE state.

Step 1004: Do not initiate a RRC connection reestablishment procedure, when the UE in the RRC_INACTIVE state fails to complete the transmission within the maximum number of retransmissions of the first PDU.

Step 1006: End.

In one example, the first PDU includes an IP packet or a RRC message.

In one example, the UE in a RRC_CONNECTED state initiates a transmission of a second PDU (e.g., including an IP packet or a RRC message). The UE initiates the RRC connection reestablishment procedure, when the UE in the RRC_CONNECTED state fails to complete the transmission of the second PDU within (or after) the maximum number of retransmissions of the second PDU.

In one example, the UE initiates a transmission of a PDU (e.g., including an IP packet or a RRC message). The UE detects a transmission problem occurs in the transmission of the PDU. For example, the transmission problem is that the UE fails to complete the transmission of the PDU within (or after) the maximum number of retransmissions of the PDU. If the UE is in the RRC_INACTIVE state and detects the transmission problem, the UE does not initiate the RRC connection reestablishment procedure in response to the transmission problem. If the UE is in the RRC_CONNECTED state and detects the transmission problem, the UE initiates the RRC connection reestablishment procedure.

In one example, the UE “disables initiating” (or “is not allowed to initiate”) the RRC connection reestablishment procedure, when entering the RRC_INACTIVE state. That is, when the UE in the RRC_INACTIVE state detects the transmission problem, the UE does not initiate (or not perform) the RRC connection reestablishment procedure. The UE “enables initiating” (or “is allowed to initiate”) the RRC connection reestablishment procedure, when entering the RRC_CONNECTED state.

In one example, the UE “disables detecting” (or “is not allowed to detect”) the transmission problem, when entering the RRC_INACTIVE state. That is, the UE in the RRC_INACTIVE state does not detect the transmission problem. Thus, the UE does not initiate the RRC connection reestablishment procedure in the RRC_INACTIVE state. The UE may keep transmitting the first PDU or initiating the transmission of the first PDU until a timer expires. When the timer expires, the UE stops transmitting the first PDU. The UE may start the timer, when initiating the transmission of the first PDU. When the UE successfully transmits the first PDU or receives a second PDU (e.g., including an IP packet or a RRC response message) for responding to the first PDU, the UE may stop the timer. The UE enables detecting the transmission problem, when entering the RRC_CONNECTED state (e.g. from the RRC_INACTIVE state or the RRC_IDLE state).

The following examples can be applied to the above processes.

In one example, to initiate/perform the RRC connection reestablishment procedure, the UE transmits a RRCConnectionReestablishmentRequest message. When the UE does not initiate/perform the RRC connection reestablishment procedure, the UE does not transmit the RRCConnectionReestablishmentRequest message to a BS via a cell.

Those skilled in the art should readily make combinations, modifications and/or alterations on the abovementioned description and examples. For example, the skilled person easily makes new embodiments of the network based on the embodiments and examples of the UE, and makes new embodiments of the UE based on the embodiments and examples of the network. The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means may be the communication device 20. Any of the above processes and examples above may be compiled into the program code 214.

To sum up, the present invention provides a method and a communication device for handling an inactive state. The communication device in the inactive state can perform proper operations, when the communication device detects a RA problem or the communication device fails to complete a transmission. Thus, the problem related to the inactive state is solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device of handling an inactivate state, comprising:
a storage device; and
a processing circuit, coupled to the storage device, wherein the storage device stores, and the processing circuit is configured to execute instructions of:
entering a RRC_INACTIVE state;
initiating a random access (RA) procedure for transmitting data, when the communication device is in the RRC_INACTIVE state;
detecting that a RA problem occurs in the RA procedure; and
transferring to a RRC_IDLE state in response to the RA problem, or initiating a radio resource control (RRC) connection resume procedure or a RRC connection reestablishment procedure in response to the RA problem.

2. The communication device of claim 1, wherein the data comprises an internet protocol (IP) packet.

3. The communication device of claim 1, wherein the communication device detects the RA problem, when the communication device has transmitted the maximum number of transmissions of at least one preamble.

4. A communication device of handling an inactivate state, comprising:
a storage device; and
a processing circuit, coupled to the storage device, wherein the storage device stores, and the processing circuit is configured to execute instructions of:
entering a RRC_INACTIVE state;
initiating a transmission of a Protocol Data Unit (PDU), when the communication device is in the RRC_INACTIVE state; and
transferring to a RRC_IDLE state when the communication device fails to complete the transmission within the maximum number of retransmissions of the PDU, or initiating a radio resource control (RRC) connection resume procedure or a RRC connection reestablishment procedure when the communication device fails to complete the transmission within the maximum number of retransmissions of the PDU.

5. The communication device of claim 4, wherein the PDU is a Packet Data Convergence Protocol (PDCP) PDU, a radio link control (RLC) PDU or a medium access control (MAC) PDU.

6. The communication device of claim 4, wherein the PDU comprises an internet protocol (IP) packet or a RRC message.

7. The communication device of claim 4, wherein the communication device fails to complete the transmission of the PDU to the network, if the communication device does not receive any acknowledgement for acknowledging a reception of the PDU from the network.

8. A communication device of handling an inactivate state, comprising:
a storage device; and
a processing circuit, coupled to the storage device, wherein the storage device stores, and the processing circuit is configured to execute instructions of:
initiating a first random access (RA) procedure for a data transmission, when the communication device is in a RRC_INACTIVE state;
detecting that a RA problem occurs in the RA procedure; and
not initiating a radio resource control (RRC) connection reestablishment procedure in response to the RA problem.

9. The communication device of claim 8, wherein the instructions further comprise:
initiating a second RA procedure for the data transmission, when the communication device is in the RRC_INACTIVE state;
detecting that the RA problem occurs in the RA procedure; and
initiating the RRC connection reestablishment procedure in response to the RA problem.

10. The communication device of claim 8, wherein the data transmission comprises a transmission of an internet protocol (IP) packet or a RRC message.
